(19) United States
(12) Patent Application Publication
(10) Pub. No.: US 2007/0246474 A1
(43) Pub. Date: Oct. 25, 2007

(54) PAINT TRAY AND METHOD FOR MANUFACTURE

(76) Inventor: Millard F. Wallace, Orwigsburg, PA (US)

Correspondence Address: WILLIAM J. MASON;MACCORD MASON PLLC, POST OFFICE BOX 1489, WRIGHTSVILLE BEACH, NC, 28480, US

(21) Appl. No.: 11/734,285

(22) Filed: Apr. 12, 2007

Related U.S. Application Data
(60) Provisional application No. 60/794,409, filed on Apr. 24, 2006.
(60) Provisional application No. 60/855,597, filed on Oct. 31, 2006.

(51) Int. Cl. B05C 21/00

(52) U.S. Cl. 220/570

(57) ABSTRACT

A preformed paint tray with peelable liners is made from a planar tray substrate with upper and lower surfaces and a plurality of stacked liner sheets with peelable adhesive on one surface by positioning the liner sheets adjacent a surface of the substrate, and simultaneously thermoforming the substrate and sheets together to form a substrate having a shaped interior, with the sheets conforming to the shaped interior of the substrate. The sheets are maintained in the thermoformed shape by their adherence to the other sheets and the substrate. If desired, the sheets can include tear tabs to facilitate separation of the top sheet from the other sheets. The tray can be cleaned of residual paint after use by simply peeling away the upper liner sheet.

This application claims the benefit of the filing dates of U.S. Provisional Application Ser. No. 60/794,409, filed Apr. 24, 2006, and U.S. Provisional Application Ser. No. 60/855,597, filed Oct. 31, 2006.

### FIELD OF THE INVENTION

The present invention relates generally to a paint tray for use in applying paint to a surface with a paint roller, and in particular to a paint tray having a plurality of layers of a peelable surfacing film, whereby the paint tray can be cleaned after use by peeling away the upper film surface. The invention also relates to a method for converting multi layers of material into a roll and forming the paint tray with adhered layers. Also the method could lend itself to a number of other markets other than paint trays, i.e., trashcans, buckets, metal paint trays, cat litter containers, camping plates, medical trays, etc.

### BACKGROUND OF THE INVENTION

Paint is commonly applied to walls and other surfaces with a paint roller comprised of a roll of napped textile material or other paint absorbent substrate carried on a handle, and a metal or plastic paint-holding tray into which the roller is placed to load the roll with paint. While useful in quickly applying a uniform paint coating to large surfaces, a major disadvantage of the use of this system is the required messy and time consuming chore of cleaning the roller and tray after use. The present application relates to an improved tray that enables the user to avoid tray cleaning, and to a tray with two wells divided by a flat section designed specifically to properly distribute paint on the roller nap. The tray configuration is also designed to lend itself to thermoforming.

In an attempt to minimize cleaning, the prior art describes a preformed paint tray liner that is placed into the interior of a paint tray. Generally, these liners are thermoformed from a plastic sheet having a thickness of from about 0.008 to about 0.03 inches. The paint is poured into this liner, which is removed and discarded along with any adhered paint after the paint job is completed. While effective in eliminating the need to clean the paint tray, these preformed liners are sufficiently expensive that many users attempt to clean and reuse the liners. Their thickness adds significantly to environmental waste upon disposal. The preformed tray liners also require separate additional storage prior to use.

Other prior art as exemplified by U.S. Published Apn. No. 2004/0112902 to Campbell and U.S. Published Apn. No. 2006/0037960 to Rosa manually presses an impervious plastic sheet having a thickness of from about 0.5 to about 5 mils and an adhesive backing into a previously formed paint tray so that the sheet approximately conforms to the tray. The sheet is peeled away and discarded after use. While less expensive than preformed tray liners, these sheets are awkward and time consuming to individually hand press into place and do not provide a functional liner that exactly conforms to the tray interior, especially in the corners of the tray.

Thus, there is a continuing need for a paint tray having a properly fitted, factory applied, functional, disposable liner that avoids the necessity of cleaning the paint tray after every use. There is a further need for a method of manufacturing a paint tray with a plurality of disposable liners and a method of manufacturing a plurality of formed trays more efficiently.

### SUMMARY OF THE INVENTION

Generally, the present invention is comprised of a paint tray with a plurality of peelable liners that are simultaneously thermoformed with the tray, with the liners being thermoformed to the shape of the tray interior surface at the same time the tray is formed. As used herein, the term “thermoformed” is intended to encompass various methods of shaping a thermoplastic sheet or stacked sheets by heating the sheet and applying a pressure differential to the opposed side of the sheet to conform the sheet to the shape of a mold surface.

While the invention will be described in terms of the preferred embodiment of simultaneously thermoforming a substrate and a plurality of liner sheets or simultaneously thermoforming a plurality of similar thin wall substrates with a release agent/barrier on the inner or bottom surface, it will be understood after reading the disclosure that the invention is also applicable to simultaneously forming a substrate and a single liner sheet, and to shaping the liner sheets and substrate by other means, e.g., by stamping, injection molding or blow molding. The substrate, while preferably a thermoformable plastic, may also be of other materials, e.g., metals.

In one example of thermoforming known as vacuum molding, a sheet is positioned adjacent a female mold section and a vacuum is applied to draw the sheet against the mold surface. A male mold section may be pressed against the sheet on the opposite side of the sheet from the female mold section to assist in conforming the sheet to the shape of the female mold section. In other processes, such as pressure forming, the heated sheet is pressed against a male mold section, usually with the assistance of a vacuum to conform the sheet to the mold shape.

In a preferred embodiment of the present invention, a plurality of stacked planar sheets of thin plastic serving as disposable liners (“liner sheets”) are positioned on a surface of a planar substrate sheet of a greater thickness to be formed into a paint tray. The combination of a stack of liner sheets and a single substrate makes a “tray sheet”. The liner sheets will preferably be significantly thinner than the substrate sheet, e.g., the liner sheets may be from about 1 mil to about 6 mils thick, while the substrate sheet may be from about 10 mils to about 40 mils thick.

Each liner sheet has an adhesive on its inner or bottom surface to secure the liner sheets to the immediately adjacent sheet, with the innermost or bottom liner sheet being adhered to the top surface of the substrate sheet. Preferably, the adhesive backing is a uniform coating of adhesive over the entire inner surface of the sheets except where tear tabs are located. While applying the adhesive in making the liner sheets, the tabs can be added in line, anywhere in part or whole around the perimeter of where the tray will be formed. This is done by deadening the adhesive. Tabs are applied to each liner sheet to facilitate separation of the sheets. Suitable adhesives will be apparent to one skilled in the art, the requirement being that the adhesive is a peelable adhesive, i.e., an adhesive that will permit separation of one liner sheet from another liner sheet or the substrate without tearing the liner sheet.

The tray sheets can be shipped in either sheet form or roll form. For convenience in shipping, storage, and thermoforming, the tray sheet may be provided to the thermoformer in a continuous roll form (“master pad roll”). The roll can be continuously fed through the thermoformer, with each length of tray sheet being indexed, then thermoformed into a shape, i.e. paint tray. The roll length and width can be as desired. For example, the master pad roll can be 5″ to 48″ in width.

The combined stack of sheets (tray sheets), is thermoformed as a unit into the shape of the desired product, e.g., a paint tray with the liner sheets being on the interior of the paint tray. Upon cooling, the tray sheet maintains its thermoformed configuration due to the thickness of the substrate sheet, while the configuration of the liner sheets is assisted by the presence of the adhesive backing.

The paint tray is used like one would use an ordinary paint tray that does not have a liner. However, unlike the prior art trays described above, there is no need to place a preformed liner into the tray or attempt to hand shape a sheet of thin plastic to conform to the tray interior. After use, the upper liner sheet can be simply peeled away along with the paint residue, exposing the next liner sheet as a clean paint tray ready for use.

The mold, and thereby the thermoformed tray system, can be of various shapes. Generally, the resultant tray will have an open-top interior cavity with a floor and continuous side walls. The paint tray may include at least one paint well and a flat section, normally ridged, for removal of excess paint from a roller dipped into paint within the paint well. In a preferred embodiment, the improved tray may be comprised of two paint wells divided by a horizontal, flat central section so that paint can be placed in both wells. The flat section is connected to opposed ramps tapering upwardly from the paint wells.

In another embodiment of the invention, multiple containers such as plastic egg cartons, cookie trays (e.g., Oreo), jello containers, blister packs, rigid paint tray liners etc., are produced by simultaneously thermoforming multiple layers of plastic sheets having the same thickness. Sheets used in this application are generally from about 0.006″ to about 0.025″ thick. Preferably, a stack of sheets, e.g., from 4 to 6 sheets, are provided to the thermoformer in roll form. A release agent, e.g., a coating, adhesive barrier or release film is applied between the sheets to prevent the sheets from melting/bonding together during the thermoforming process, and to allow the finished containers to be separated easily (e.g., a form of silicone may be introduced between the layers of sheets. A zone coat of adhesive (e.g., 1 inch wide) may be applied along the edge of the substrate to allow for easier transport of the rolls of substrates and sheets by keeping the material together in roll form more effectively. Stacks of sheets are thermoformed by being drawn or pressed into a mold having the desired cavity shape.

### BRIEF DESCRIPTION OF THE DRAWINGS

FIG. 1 is a perspective view of a roll of stacked liner sheets and a substrate sheet (master PAD roll) ready for thermoforming.

FIG. 2 is a sectional side view of a tray sheet section positioned between heaters prior to thermoforming.

FIG. 3 is a sectional side view of a heated tray sheet section positioned in a thermoforming apparatus prior to thermoforming.

FIG. 4 is a sectional end view of a thermoformed tray system prior to ejection from the thermoforming apparatus.

FIG. 5 is a detailed sectional side view of a segment of a stack of liner sheets and a substrate sheet.

FIG. 6 is a top view of a preferred tray system.

FIG. 7 is a top view of an alternative preferred tray system.

FIG. 8 is a side view of an alternative tear tab assembly.

FIG. 9 is a side view of another alternative tear tab assembly.

FIG. 10 is a side view of yet another alternative tear tab assembly.

FIG. 11 is a side view of yet another tear tab assembly.

FIG. 12 is a side view of a pad of liner sheets.

FIG. 13 is a sectional side view of a stamping apparatus and a pad of liner sheets.

FIG. 14 is a side view of a stack of substrate and sheets.

FIG. 15 is a sectional side view of a stack of substrate and sheets in preparation for molding into a female cavity mold.

FIG. 16 is a sectional side view of a stack of substrate and sheets molded into a female cavity mold.

### DETAILED DESCRIPTION OF THE INVENTION

In the following description, terms such as horizontal, upright, vertical, above, below, beneath, and the like, are used solely for the purpose of clarity in illustrating the invention, and should not be taken as words of limitation. The drawings are for the purpose of illustrating the invention and are not intended to be to scale.

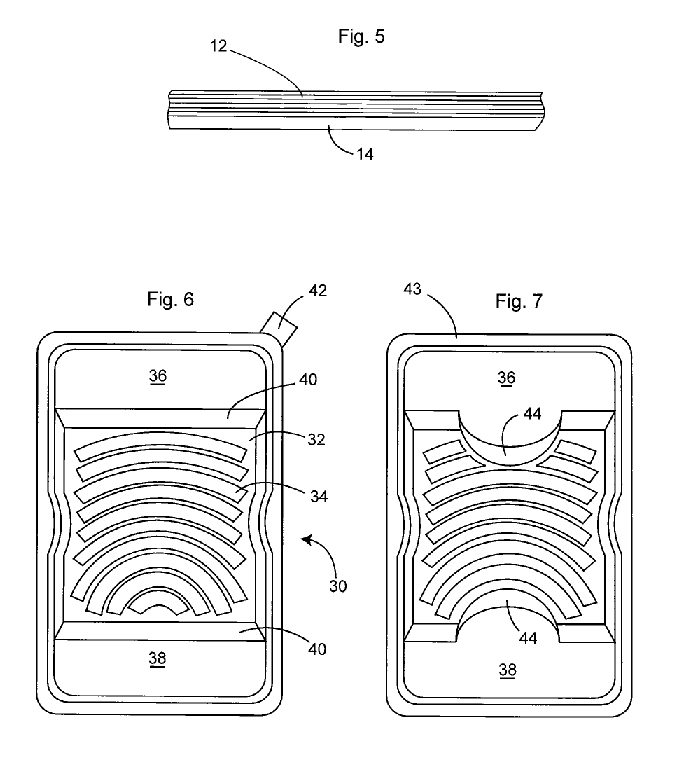

As illustrated in FIGS. 1 and 5, tray sheet 10, comprised of a plurality of liner sheets 12 and a bottom substrate sheet 14, is shipped to the thermoformer as a roll 16.

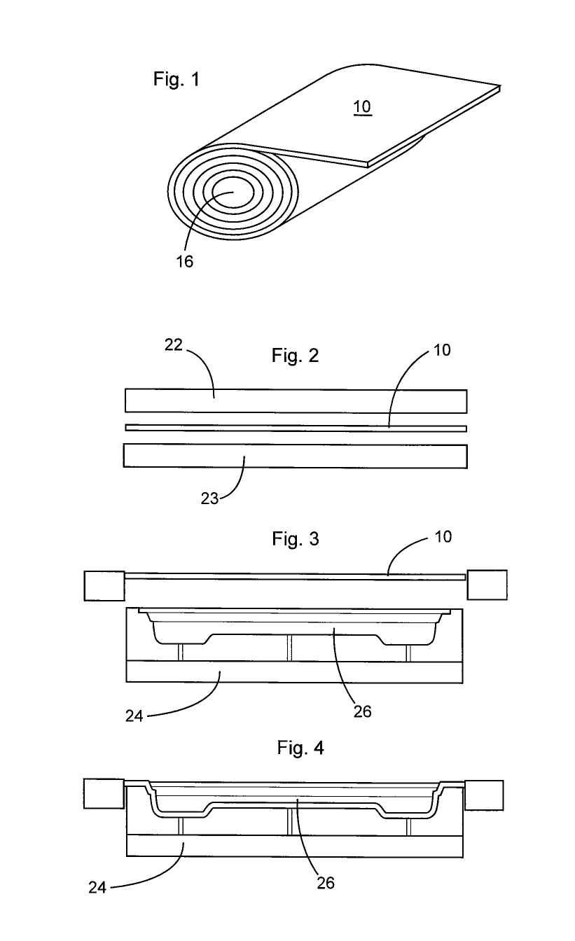

As illustrated in FIG. 2, tray sheet 10 is pulled via the thermoforming machine from roll 16 and positioned within a thermoforming apparatus comprised of upper and lower heaters 22 and 23 to heat the sheet to a moldable state. While both ovens can be heated simultaneously, they also may need to be adjusted independently of one another. The heated sheet is then pulled further to a position over a vacuum source 24 as illustrated in FIG. 3. A female mold 26 conforming to the desired shape of the tray system is positioned in communication with vacuum source 24. Heated sheet segment 10 is lowered onto mold 26 and a vacuum is drawn on mold 26 with vacuum source 24, shaping sheet segment 10 to the interior contours of mold 26 as shown in FIG. 4. The molded tray system is then cooled and ejected from mold 26, and edge trimmed if desired.

The resultant product is a thermoformed tray system comprised of a substrate sheet in the shape of the desired tray, with a plurality of liner sheets stacked thereon and held in place by adhesive layers, both natural or man made, between the liner sheets and the lowermost liner sheet and the upper surface of the substrate sheet. All sheets are molded into the shape of the desired tray.

A preferred tray 30 is illustrated in FIG. 6. Tray 30 is comprised preferably of a horizontal, flat central shelf 32 with ridges 34 to remove excess paint from a paint roller rolled across shelf 32, down ramps 40 and paint wells 36 and 38 on opposite sides of ramps 40. Tear tab 42 can be located anywhere on the perimeter of all liner sheets, or all or part of the entire perimeter of the liner sheet can form a tab 43 for use in separating the liners. An alternative tray configuration is illustrated in FIG. 7, showing the addition of feet 44 for added stability.

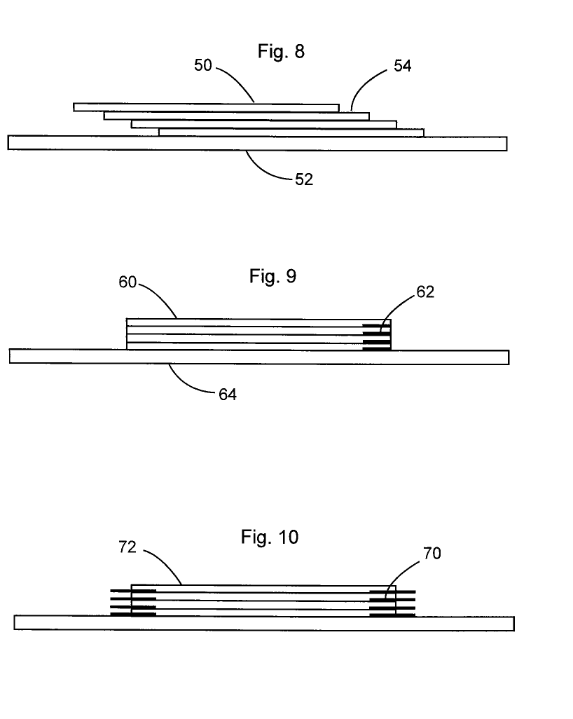

Various other means may be used to include tabs to facilitate separation of the tapes. For example, as shown in FIG. 8, the layers of liner sheets 50 may be stepped during the converting process where the substrate 52 and liner sheets 50 are formed into a roll. The resulting look will be like steps 54 on the edges, allowing the consumer to see the edges of all the layers.

In another alternative shown in FIG. 9, the liner sheets 60 may be “strip coated” before it is made into the roll form. That is, adhesive is applied to the body of the liner sheets 60, except for the area of the tabs 62. Thus, the liner sheets 60 have adhesive except for the edges (e.g., ½″), either on one side or both sides of the liner sheets. The end result is the edges of the paint tray will have no adhesive on the “tabs” 62, allowing the consumer to identify and begin peeling the layers.

Yet another alternative as shown in FIG. 10, is to use actual separate tabs 70 on the edges of the liner sheets 72 to distinguish between layers. The separate tabs 70 could be tape/film of plastic or paper (e.g. ¾″ wide, with or without adhesive) to be applied on the ends of the protective tape on either the top or bottom preferably the bottom (this side of the protective tape has the adhesive). This tape/film could be of various colors and designs and will serve as an aid for the consumer to pull apart the layers of liner sheets 72.

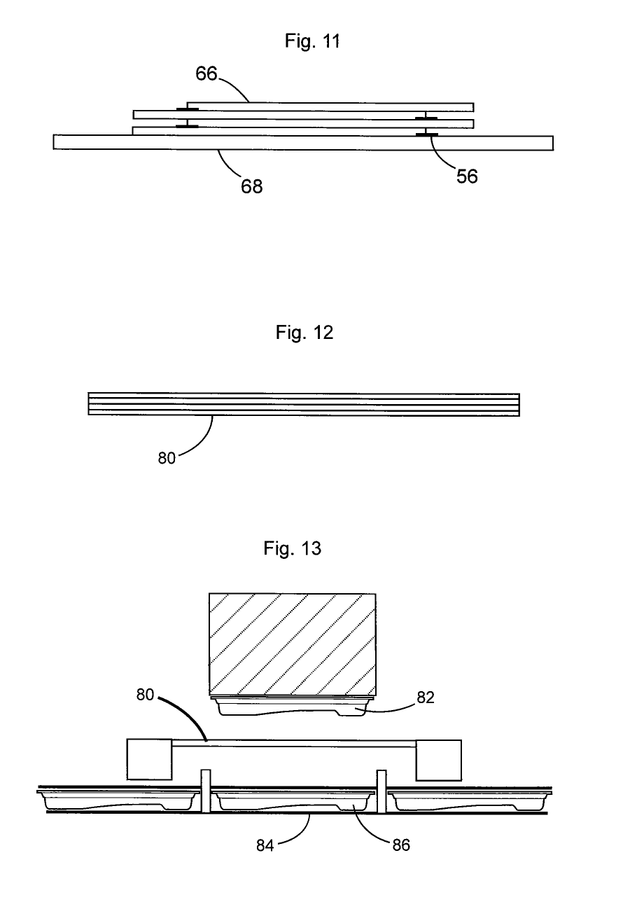

Yet another alternative is shown in FIG. 11, using actual separate tabs 56 on the edges of the liner sheets 66 to distinguish between layers, however tabs 56 are applied on opposing edges of sequencing liner sheets 66, while liner sheets 66 are shifted, creating a pitter patter effect with tabs 56 hidden underneath top liner sheets 66 until top layer is removed. The separate tabs 56 could be tape/film of plastic or paper (e.g. ¾″ wide, with or without adhesive) to be applied on the ends of the protective tape on either the top or bottom, preferably the bottom (this side of the protective tape has the adhesive). This tape/film could be of various colors and designs and will serve as an aid for the consumer to pull apart the layers of liner sheets 66.

While the invention is described primarily in terms of the manufacture of a paint tray with a stack of thermoformed sheet liners conforming to the interior dimensions of the paint tray, it will be apparent that the broad concept of the invention can be modified for other applications. For example, as illustrated in FIGS. 12 and 13, instead of simultaneously shaping the substrate that forms the tray or other product and the liner sheets, the substrate can be initially formed into the tray, or the tray can be otherwise manufactured. A pad of liner sheets 80 can then be formed within the tray. That is, a mold of the image of the product, e.g., paint tray 82, is suspended above the product (e.g. paint tray in plastic or metal) and sandwiched in between is a continuous roll of liner sheets 80. The paint tray will be moving along a conveyor 84 and when the paint tray is nested opposing the mold image of the product 86, the two parts are “stamped” together, thus creating the finished product with the pads of liner sheets.

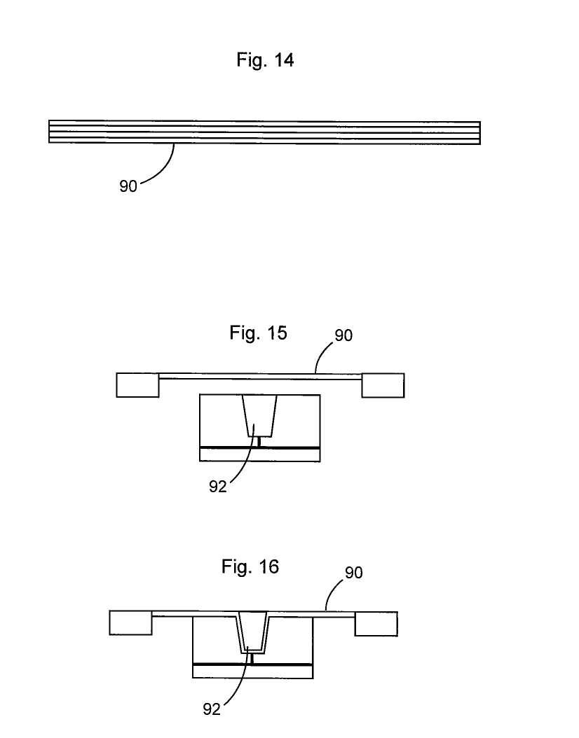

In another alternative illustrated in FIGS. 14-16, multiple layers of plastic sheets 90 having the same thickness, instead of liner sheets/protective tape, can be thermoformed simultaneously, in order to make multiple products. Applied applications for this would be various containers such as plastic egg cartons, cookie trays (e.g., Oreo), Jello containers, blister packs, rigid paint tray liners etc. The substrate is a more rigid material, while the liner sheets/protective tape is more stretchable and pliable, such as a garbage bag. The plastic sheets 90 in this process are of a lesser thickness than the paint tray of 0.030″, but not as thin as the liners of protective tape.

This latter process ideally uses about 3 to 6 layers in roll form. Currently the maximum thickness to thermoform (in roll form) effectively is around 0.050″. A coating, adhesive barrier, release agent, or film will be applied to or placed in between the sheets where needed and in any combination to prevent the sheets from melting/bonding together in the thermoforming process, and for allowing the finished products to be separated easily (e.g., a form of silicone may be introduced between the layers of sheets while a zone coat of adhesive (e.g., 1 inch wide) may be applied along the edge of the substrate). This adhesion allows for easier transport of the roll of sheets by keeping the material together in roll form more effectively. Multiple sheets of approximate thickness 0.010″ each are stacked together with a barrier/adhesion between each layer. The multi-sheet layers are rolled together and then sold to various thermoforming companies. Ultimately time and money are saved by the thermoformers, allowing them to be more efficient. Sheets 90 are thermoformed by being drawn or pressed into a mold 92 having the desired cavity shape.

Certain modifications and improvements will occur to those skilled in the art upon a reading of the foregoing description. It should be understood that all such modifications and improvements have been deleted herein for the sake of conciseness and readability but are properly within the scope of the following claims.

What is claimed is:

1. A container with a disposable liner comprising:
a) a shaped substrate having an interior surface; and
b) at least one peelable liner having an upper surface and a lower surface, said liner conforming to the shape of said interior surface and being attached to said interior surface with an adhesive, whereby said liner can be peeled from said substrate, said substrate and liner being formed simultaneously.

2. The container of claim 1, wherein said substrate and liner are thermoformed.

3. The container of claim 1, wherein said substrate includes a plurality of liners with upper and lower surfaces including a bottom liner, each of said liners except for said bottom liner having a lower surface adhered to the upper surface of another liner, said bottom liner being adhered to said substrate.

4. The container of claim 1, wherein said substrate has a given thickness, said liner having a thickness less than said given thickness.

5. The container of claim 1, wherein said substrate interior has two reservoirs separated by a horizontal section.

6. The container of claim 1, wherein said liner includes a tear tab.

7. A preformed paint tray with disposable liners comprising:
a) a thermoformed tray having an interior surface; and
b) a plurality of thermoformed liner sheets including a bottom liner, each liner having a shape conforming to the shape of said interior surface, each of said liners except for said bottom liner having a lower surface releasibly adhered to the upper surface of another liner, said bottom liner being releasibly adhered to said tray, said substrate and liner sheets being simultaneously thermoformed.

8. The tray of claim 7, wherein said substrate has a given thickness, said liner having a thickness less than said given thickness.

9. The tray of claim 7, wherein said substrate interior has two reservoirs separated by a horizontal section.

10. The tray of claim 7, wherein each of said liner sheets includes a tear tab.

11. The tray of claim 7, wherein said substrate and liner sheets are vacuum or pressure formed.

12. The tray of claim 7, wherein said tray has stabilizing feet.

13. The tray of claim 7, including from three to six liner sheets.

14. A method of making a container with an interior open-topped cavity and at least one peelable liner comprising:
a) providing a planar substrate with a surface;
b) providing a liner sheet having a surface;
c) attaching said liner sheet surface to said substrate surface with a peelable adhesive; and
d) simultaneously thermoforming said substrate and sheet to form a substrate with an open-topped cavity with said sheet conforming to said cavity and being adhered to said substrate with said adhesive.

15. The method of claim 14, wherein said container is thermoformed by heating said substrate and said sheet and simultaneously vacuum or pressure forming said substrate and sheet.

16. The method of claim 14, wherein said sheet includes tear tabs.

17. The method of claim 14, wherein said liner sheet is provided as part of a multi-sheet roll.

18 The method of claim 14, wherein said liner sheets each have a thickness of from about 1 mil to about 7 mils and said substrate has a thickness of from about 10 mils to about 40 mils.

19. The method of claim 14, wherein said container is a paint tray.

20. A method of making a plurality of containers with interior open-topped cavities comprising:
a) providing a plurality of stacked planar thermally deformable sheets;b) simultaneously thermoforming said sheets to form containers with interior open-top cavities; and
c) separating said thermoformed sheets.

21. The method of claim 20, including the step of providing said stacked sheets as part of a multi-sheet roll.

22. The method of claim 20, including the step of applying a release agent to said sheets before stacking.

23. The method of claim 20, wherein said sheets are the same thickness.
